(19) United States
(12) Patent Application Publication
(10) Pub. No.: US 2006/0265475 A9
(43) Pub. Date: Nov. 23, 2006

(54) Testing web services as components

(76) Inventors: Thomas Mayberry, Holliston, MA (US); Kevin Putnam, Derry, NH (US); George Friedman, Framingham, MA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 09/975,398

(22) Filed: Oct. 11, 2001

Related U.S. Application Data
(60) Provisional application No. 60/277,072, filed on Mar. 19, 2001.

(51) Int. Cl. G06F 15/16

(52) U.S. Cl. 709/219; 709/218; 709/202

(57) ABSTRACT

The present invention provides a method of testing Web Services as software components. The present invention provides a method by which a Web Service is located on a remote system. After the Web Service has been located, tests are generated for exercising the various methods of the Web Service. The tests are run, exercising the Web Service, and the results are made available to verify the performance of the Web Service.

### BACKGROUND OF THE INVENTION

Componentized software is software that is designed to allow different pieces of the application, known as “software components” or “objects”, to be created separately but still to have the objects work together. The objects have standard interfaces that are understood and accessed by other objects. Some parts of these interfaces are enforced by the software language. If the interfaces are not used, the software objects will not be able to work with other objects.

An example of a software component is an Enterprise Java Bean™ software component (EJB). EJBs are written in the JAVA language, which is intended to be “platform independent.” Platform independent means that an application is intended to perform the same regardless of the hardware and operating system on which it is operating. Platform independence is achieved through the use of a “container.” A container is software that is designed for a specific platform. It provides a standardized environment that ensures the application written in the platform independent language operates correctly. The container is usually commercially available software and the application developer will buy the container rather than create it.

Typically, applications comprising combinations of software components have been tested in one of two manners. In the first manner, the objects are tested as they are written. Each object is tested to ensure that it performs the intended function. In the second manner, the objects are assembled into a completed application and the entire application is then usually tested. Heretofore, application testing has generally been done by applying test inputs at the client end and observing the response of the application. There are several shortcomings with this process. One is that it is relatively labor intensive, particularly to develop a load or scalability test. There has been no easy way to create the test program, instantiate it with test data, execute the test and aggregate the results.

Other tools are available to automate the execution of tests on applications. For example, Empirix Inc. of Waltham, Mass., provides a product called e-Load. This tool simulates load on an application under test and provides information about the performance of the application. However, this tool does not provide information about the components in an application. Another tool known as Bean-test™ also available from Empirix Inc. of Waltham, Mass., tests individual software components.

Automatic test generation tools, such as TestMaster available from Empirix Inc. of Waltham, Mass., are also available. Tools of this type provide a means to reduce the manual effort of generating a test. TestMaster works from a state model of the application under test. Such an application is very useful for generating functional tests during the development of an application. Once the model of the application is specified, TestMaster can be instructed to generate a suite of tests that can be tailored for a particular task—such as to fully exercise some portion of the application that has been changed. Model based testing is particularly useful for functional testing of large applications, but is not fully automatic because it requires the creation of a state model of the application being tested. While all of the above decribed tools have proved to be useful for testing software components and applications which include software components, they are not able to test Web Services.

A Web Service is programmable application logic which is accessible using standard Internet protocols such as Hypertext Transfer Protocol (HTTP). Web services represent black-box functionality that can be reused without worrying how the service is implemented. Web services use a standard data format such as Extensible Markup Language (XML). A Web Service interface is defined in terms of the messages the Web Service accepts and produces. Users of the Web Service can be utilizing any platform in any programming language as long as they can create and consume the messages defined for the Web Service interface.

While software components can be tested by commercial software as described above, the testing of Web Services is more difficult. It would be desirable to have a product which can locate a Web Service across a network such as the Internet, generate tests for the Web Service, and verify the performance of the Web Service.

### SUMMARY OF THE INVENTION

With the foregoing background in mind, it is an object of the present invention to provide a method of testing Web Services as software components. The present invention provides a method by which a Web Service is located on a remote system. After the Web Service has been located, tests are generated for exercising the various methods of the Web Service. The tests are run, exercising the Web Service, and the results are made available to verify the performance of the Web Service.

### BRIEF DESCRIPTION OF THE DRAWINGS

The invention will be better understood by reference to the following more detailed description and accompanying drawings in which:

FIG. 1 is a block diagram of a system for implementing the present invention; and

FIG. 2 is a flow chart of the method of the present invention.

### DETAILED DESCRIPTION

In testing software components such as an Enterprise Java Bean™ (EJB or bean) a test system contains scripts to implement various types of load tests. While any type of software component may be used, an EJB software component is used in this description for explanation purposes. One type of load test determines response time of an EJB. This allows the test system to vary the load on the EJB and determine degradation of response time in response to increased load. Another type of load test is a regression type load test. In a regression type test, the script runs operations to determine whether the EJB responds the same way as it did to some baseline stimulus. In general, the response to the baseline stimulus represents the correct operation of the EJB. Having a regression type test allows the test system to increase the load on a bean and determine the error rate as a function of the load supplied.

To generate test code for these types of load tests, the script must create test code that is specific to the bean under test. The user provides information on which bean to test. This information specifies where in the network to find the bean under test. The script uses this information to ascertain what test code must be generated to test the bean.

The script can generate code by using the attributes of the platform independent language in which the bean is written. For the example of Sun JAVA language being used here, each bean has an application program interface called a “reflection.” More particularly, each bean has a “home” interface and a “remote” interface. The “home” interface reveals information about the methods for creating or finding a remote interface in the bean. The remote interface reveals how this code can be accessed from client software. The home and remote interfaces provide the information needed to create a test program to access and exercise the bean.

Using the reflection, the test system software determines what are known as the “properties” and “methods” of a bean. The properties of a bean describe the data types and attributes for a variable used in the bean. Every variable used in the bean must have a property associated with it. In this way, the script can automatically determine what methods need to be exercised to test a bean and the variables that need to be generated in order to provide stimulus to the methods. The variables that will be used by the methods as they are tested can also be determined.

The methods of a bean describe the functions that bean can perform. Part of the description of the method is the properties of the variables that are inputs or outputs to the method. A second part of the description of each method—which can also be determined through the reflection interface—is the command needed to invoke this method. Because the script can determine the code needed to invoke any method and, as described above, can generate data values suitable to provide as inputs to that method, the script can generate code to call any method in the bean.

Once the commands that exercise the methods of an EJB are created, the script can also insert into the client test code the commands that are necessary to record the outputs of the test. If a test is checking for numbers of errors, then the test code needs to contain instructions that record errors in a log. Likewise, if a test is measuring response time, the test code must contain instructions that write into the log the information from which response time can be determined.

In some instances all major database functions can be exercised with no user supplied test code. In some instances, it might be possible to exercise all the functions with all test data automatically generated. All the required information could be generated from just the object code of the application under test. An important feature of the method is that it is “minimally invasive”—meaning that very little is required of the user in order to conduct a test and the test does not impact the customer's environment. There is no invasive test harness. The client code runs exactly like the code a user would write.

While the above described method works well for certain software components such as EJBs, it cannot be used to test Web Services. A Web Service is programmable application logic accessible using standard Internet protocols. Similar to software components, Web Services provide functionality that can be used multiple times and by multiple different applications running on multiple different systems. Web services are accessed via web protocols such as Hypertest Transfer Protocol (HTTP) and by data formats such as Extensible Markup Language (XML). A Web Service interface is defined in terms of messages the Web Service can accept and generate. Users of the Web Service can be implemented on any platform and in any programming language, as long as they can create and consume the messages defined for the particular Web Service being utilized.

A protocol has been defined for performing information interchange with Web Services. This protocol is the Simple Object Access Protocol (SOAP). Typically objects are platform dependent, thus an object created on one platform cannot be used by software running on other platforms. Some distributed object technologies require the use of specific ports to transmit their data across the Internet (for example, DCOM uses port 135). Most firewalls prevent the use of all ports except for port 80, which is the default port for HTTP communications.

SOAP provides a platform independent way to access and utilize Web Services located on different distributed systems, and allows communications through firewalls. SOAP utilizes XML, and XML documents are transported via HTTP through firewalls.

SOAP messages are sent in a request/response manner. SOAP defines an XML structure to call a Web Service and to pass parameters to the Web Service. SOAP further defines an XML structure to return values that were requested from the Web Service. SOAP further defines an XML structure for returning error values if the Web Service cannot execute the desired function.

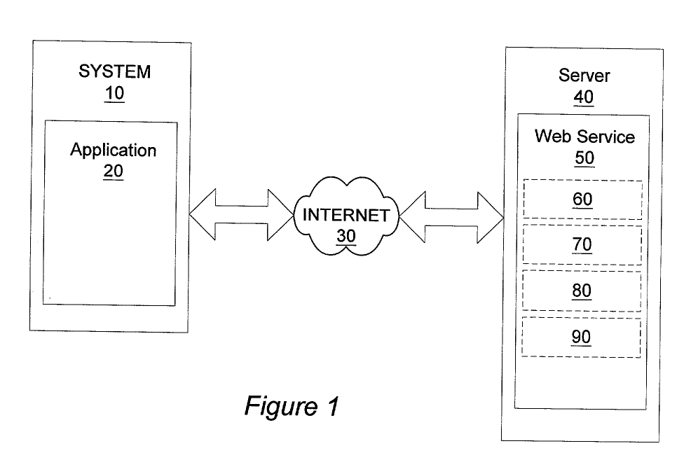

Referring to FIG. 1 a diagram showing how a Web Service may be utilized is shown. A system 40 has an application 20 residing thereon. Part of the application requires use of a particular Web Service 50 which is located on a remote machine 40. The application 20 composes a SOAP message and sends the message to server 40. The message travels across Internet 30, and is received by the remote server 40 which has the requested Web Service residing thereon. Once the SOAP message has been received by server 40, the Web Service 50 is called. Once the Web Service 50 has finished processing, a SOAP message is prepared to be sent back to the application residing on System 10. The message is sent across Internet 30 to system 10 where it is processed by application 20. In such a manner the Web Service is utilized by an application on a system remotely located from the Web Service. As described above SOAP allows systems to be highly distributed. Accordingly, developers are able to rely on the expertise and existing proven code of other developers to more quickly build more reliable systems.

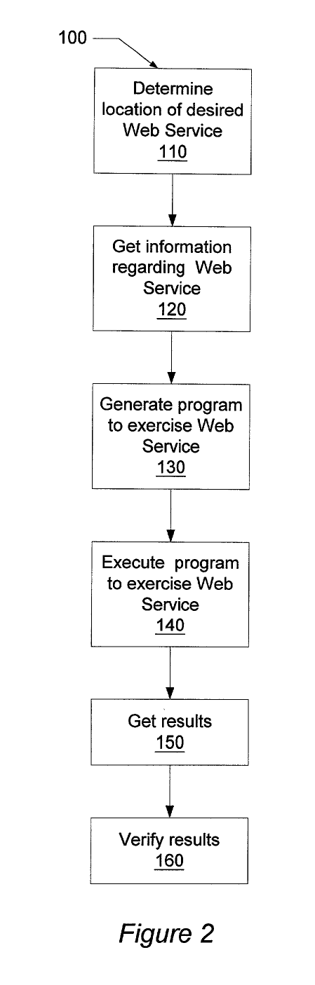

Referring now also to FIG. 2, a flowchart of the method 100 of the present invention is shown. As an example, it is desired to locate a Web Service called “Calculator” to perform a function selected from the group comprising adding a first number to a second number, subtracting a first number from a second number, multiplying a first number by a second number, or dividing a first number by a second number. In order to test a Web Service it is important to determine where a Web service resides. A Discovery Protocol (Disco) specification defines a format for discovery as well as a protocol for retrieving the discovery document. This permits developers to discover Web Services at a known URL. The Disco file resides in a predetermined place on a system. The Disco file contains a list of Web Service Descriptor Language (WSDL) files.

Each WSDL file is an XML file which contains a list of Web Services available on that system. The WSDL also contains information pertaining to the Web Services. This information includes the interface to the Web Service, the methods of the Web Service, and the parameters required by the Web Service. As an example, if a Web Service named “Calculator” was available on a machine, the WSDL file would list the “Calculator” Web Service as well as the methods (“Add Two Numbers”, “Subtract Two Numbers”, “Multiply Two Numbers”, and “Divide Two Numbers”) of the Web Service. The WSDL also contains the parameters required for the Web Service ( the two numbers to be used).

The first step 110 of the method requires determining the location of the Web Service “Calculator” 50. As discussed briefly above, this step involves locating the Web Service “Calculator” by way of a systems Disco file. The URL for the desired Web Service “Calculator” is obtained, and this URL is used for communications between the test system 10 and the server 40 on which the Web Service “Calculator” 50 is resident.

Once the Web Service “Calculator” has been located, step 120 is performed. Information relating to the Web Service “Calculator” is available from the WSDL file relating to the particular Web Service. Similar to the reflection associated with EJBs, the WSDL file contains information relating to the interface for the Web Service, the methods used by the Web Service, and the parameters required by the Web Service. For example, the Web Service “Calculator” may include four methods. These methods include a method for adding the two numbers 60, a method for subtracting the first number from the second number 70, a method for multiplying the two numbers together 80, and a method for dividing the first number by the second number 90. Once the information relating to the Web Service has been received, then step 130 can be performed.

Step 130 generates the program necessary to exercise the Web Service “Calculator”. Similar to the software tool Bean-test™ available from Empirix Inc. of Waltham, Mass., which generates test code for EJBs based on the information available from the EJBs reflection, the present method generates test code from the information available from the WSDL file of the Web Service.

Step 140 is executed next. The test code exercises the different methods of the Web Service. The Web Service in this example includes three methods. These methods may be method 60 for adding the two numbers and for verifying that the received data are numbers. If the data received were not numbers, then an error message would be created and sent back to the test system. Method 60 further prepares the result to be transmitted back to the system which requested the Web Service.

The test code will compose a SOAP message to the URL address of the server 40 and provide the parameters necessary for the Web Service 50 to perform its function. The test system will utilize the HTTP protocol to transmit the SOAP message to the Web Service at the URL address across the Internet. The SOAP message includes a tag for the Web Service “Calculator” as well as tags for the parameters (the two numbers) being passed to the Web Service and the result to be passed back to the test system.

The SOAP message is received by the remote system 40 at the URL address. The message comprises “Call Add Two Numbers paramter1=2, parameter2=3”. Once the message is received, the Web Service 50 is called and the parameters are passed to it. The method 60 of the Web Service 50 is executed, and a result is obtained.

Step 150 is executed next. A SOAP message is prepared which is used to provide the result back to the application 20 on test system 10. The message includes the name of the response and the value of the response. Once again, the HTTP protocol is employed to transmit the SOAP message back to the system 10 requesting the Web Service. Once the result is received by the test system 10, it can be checked by the application for accuracy as recited in step 160. A similar methodology is used to test other methods and to test other Web Services. In such a manner testing of Web Services as software components is accomplished

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A method of testing a Web Service as a component comprising the steps of:
identifying, on a remote system, a Web Service to be tested;
obtaining information relating to the Web Service to be tested;
generating a program to exercise the Web Service to be tested;
executing the program to exercise the Web Service to be tested; and
obtaining results from the Web Service to be tested.

2. The method of claim 1 wherein further comprising the step of verifying that said results are correct.

3. The method of claim 1 wherein said step of identifying includes locating a Web Service descriptor language (WSDL) file for the Web Service.

4. The method of claim 3 wherein said step of identifying further comprises locating a DISCO file, said DISCO file including a list of WSDL files.

5. The method of claim 1 wherein said step of obtaining information relating to the Web Service to be tested includes obtaining information relating to the Web Service interface.

6. The method of claim 1 wherein said step of obtaining information relating to said Web Service to be tested further comprises obtaining information related to the methods of the Web Service.

7. The method of claim 1 wherein said step of obtaining information relating to said Web Service to be tested further comprises obtaining information relating to parameters to be passed to said Web Service.

8. The method of claim 1 wherein said step of executing the program to exercise the Web Service to be tested includes sending and receiving messages with said Web Service.

9. The method of claim 1 wherein said remote system resides on a network.

10. The method of claim 9 wherein said network comprises the Internet.

11. The method of claim 8 wherein said messages are in a SOAP protocol.

12. The method of claim 8 wherein said messages are transported across said network using an HTTP Internet protocol.

13. The method of claim 8 wherein said messages are in an XML format.

14. A computer program product for testing a Web Service as a component, the computer program product comprising a computer usable medium having computer readable code thereon, including program code comprising:
instructions for causing a processor to identify, on a remote system, a Web Service to be tested;
instructions for causing the processor to obtain information relating to the Web Service to be tested;
instructions for causing the processor to generate a program to exercise the Web Service to be tested;
instructions for causing the processor to execute the program to exercise the Web Service to be tested; and
instructions for causing the processor to obtain results from the Web Service to be tested.

15. The computer program product of claim 13 further comprising instructions for causing the processor to verify said results.

16. The computer program product of claim 14 wherein said instructions for causing a processor to identify includes instructions for causing a processor to locate a Web Service descriptor language (WSDL) file for the Web Service.

17. The computer program product of claim 14 wherein said instructions for causing a processor to identify further comprises instructions for causing a processor to locate a DISCO file, said DISCO file including a list of WSDL files.

18. The computer program product of claim 14 wherein said instructions for causing a processor to obtain information relating to the Web Service to be tested includes instructions for causing a processor to obtain information relating to the Web Service interface.

19. The computer program product of claim 14 wherein said instructions for causing a processor to obtain information relating to said Web Service to be tested further comprises instructions for causing a processor to obtain information related to the methods of the Web Service.

20. The computer program product of claim 14 wherein said instructions for causing a processor to obtain information relating to said Web Service to be tested further comprises instructions for causing a processor to obtain information relating to parameters to be passed to said Web Service.

21. The computer program product of claim 14 wherein said instructions for causing a processor to execute the program to exercise the Web Service to be tested includes instructions for causing a processor to send and receive messages across a network with said Web Service.

22. The computer program product of claim 21 wherein said instructions for causing a processor to send and receive messages comprise instructions for causing a processor to send and receive messages using a SOAP protocol.

23. The computer program product of claim 21 wherein said instructions for causing a processor to send and receive messages with said Web Service comprises instructions for causing a processor to transmit said messages in an HTTP Internet protocol.

24. The computer program product of claim 2 wherein said instructions for causing a processor to send and receive messages with said Web Service comprise instructions for causing a processor to transmit messages in an XML format.
